(19) United States
(12) Patent Application Publication
(10) Pub. No.: US 2006/0293434 A1
(43) Pub. Date: Dec. 28, 2006

(54) Single wall nanotube composites

(75) Inventors: Arjun G. Yodh, Merion, PA (US); Mohammad F. Islam, Pittsburgh, PA (US); Mateusz B. Bryning, Philadelphia, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: The Trustees of The University of Pennsylvania, Philadelphia, PA (US)

(21) Appl. No.: 11/166,812

(22) Filed: Jun. 24, 2005

Related U.S. Application Data
(60) Provisional application No. 60/585,871, filed on Jul. 7, 2004.

(51) Int. Cl. C08K 3/04

(52) U.S. Cl. 524/495; 523/333

(57) ABSTRACT

Methods for preparing composite materials containing carbon nanotubes and a matrix material are provided. Nanotube composite materials and electrical devices made using nanotube composite materials are also provided. Composite materials composed of nanotubes near the percolation threshold provide electrical conductivities greater than about 10⁻⁹ S/cm.

### CROSS-REFRENCE TO RELATED APPLICATIONS

This application claims benefit of U.S. Provisional Application No. 60/585,871, filed on Jul. 7, 2004, the entirety of which is incorporated by reference herein.

### STATEMENT REGARDING FEDERALLY FUNDED RESEARCH

Research leading to the disclosed inventions was conducted under Federal Grant Nos. DMR-0203378 (NSF, Division of Materials Research) and NAG8-2172 (NASA, Microfluids Area). Accordingly, the U.S. Government may have rights in this invention.

### FIELD OF THE INVENTION

The invention relates to composite materials. The invention relates more particularly to composite materials including single wall carbon nanotubes.

### BACKGROUND OF THE INVENTION

Single wall carbon nanotubes (SWNTs) have recently emerged as an attractive option for making conductive composite materials. Applications for these composites include static charge dissipation, RF shielding, and field emission sources (N. Xu, Z. Wu, S. Deng, and J. Chen, J. Vac. Sci. Technol. B. 19, 1370 (2001); Q. H. Wang, A. A. Setlur, J. M. Lauerhaas, J. Y. Dai, E. W. Seelig, and R. P. H. Changa, Appl. Phys. Lett. 72, 2912 (1998)). Typically, conductive composites contain conductive particles embedded in an otherwise insulating matrix. Conductivity typically follows a percolation-like behavior (S. Kirkpatrick, Rev. Mod. Phys., 45, 574 (1973)), wherein a well-defined transition from insulator to conductor is observed at a threshold concentration of the conductive filler. It has been shown that composites made with carbon nanotubes become conductive at lower filler concentrations than compared to traditional conductive materials, such as carbon black (R. Schueler, J. Petermann, K. Schulte, and H. Wentzel, J. Appl. Polymer Science 63, 1741 (1997)). Minimizing the amount of conductive filler is appealing for many applications. In addition to a potential reduction in cost, reducing the concentration of the conductive filler helps to maintain the physical properties of the bulk material (e.g., to maintain optical clarity in clear matrices). The low threshold concentrations observed in nanotube composites are typically attributed to the high aspect ratio of nanotubes, as well as the natural tendency of nanotubes to agglomerate into chains in solution. Chain agglomeration is thought to arise as a result of strong van der Waals interactions between two or more nanotubes (L. A. Firifalco, M. Hodak, and R. S. Lee, Phys. Rev. B 62, 13104 (2000)).

The threshold conductivity of nanotubes in various polymeric matrices have been reported. In epoxy, the threshold was found to be at a weight fraction of 7.4×10⁻⁴ (J. K. W. Sandler, et al., Polymer 44, 5893 (2003)) and 1×10⁻³ in polyimide (C. Park, et al., Chem. Phys. Lett. 364, 303 (2002)). For homogeneous dispersions of noncovalently functionalized SWNTs, thresholds were observed at a weight fraction of 5×10⁻⁴ in polystyrene and 1.1×10⁻³ in polycarbonate matrices (R. Ramasubramaniam, J. Chen, and H. Liu, Appl. Phys. Lett. 83, 2928 (2003)). Multiwall Carbon Nanotube (MWNT) composites have also been studied. In epoxy, electrical conductivity was seen at volume fractions of 1×10⁻⁴ (J. Sandler, M. S. Shaffer, T. Prasse, W. Bauhofer, K. Schulte, and A. H. Windle, Polymer 40, 5967 (1999)). More recently, using partly aligned MWNT, conductivity has been reported at weight fractions as low as 2.5×10⁻⁵ (J. K. W. Sandler, J. E. Kirk, I. A. Kinloch, M. S. P. Shaffer, and A. H. Windle, Polymer 44, 5893 (2003)). These results indicate that electrically conductive composite materials can be formed using carbon nanotubes at concentrations that are quite low compared to using carbon black. However, the preparation of electrically conductive carbon nanotube composites at low concentrations, i.e., near the percolation threshold, is poorly controlled and poorly understood. Thus, there remains the need to provide composite materials having dispersed carbon nanotubes at low concentrations that exhibit electrical conductivity. There also remains the need to provide electrical devices using such composite materials.

Nanotube aggregates are typically morphologically different compared to nanotube chains that form during shear processing conditions. Without being bound by a particular theory of operation, nanotube aggregates can be described as the elementary particles of the system, whose effective aspect ratio is not necessarily related to that of the nanotubes themselves. However, SWNTs are, perhaps uniquely, an excellent model system of aggregating colloidal hard rods. This is because they are highly rigid, having the highest stiffness of any known fiber (E. W. Wong, P. E. Sheehan, and C. M. Lieber, Science 277, 1971 (1997); M. M. J. Treacy, T. W. Ebbesen, and J. M. Gibson, Nature 381, 678 (1996)). Studying their conductivity in composites can give important insight into the theory of percolating rodlike systems. In turn, the ability to predict threshold concentrations in nanotube composite materials is desirable from an application point of view. Theoretical work has focused on describing the percolation of hard rodlike systems in general. Suspensions of hard rodlike particles can be described in terms of dilute, semi-dilute, and concentrated regimes (A. M. Wierenga and A. P. Philipse, Colloids and Surfaces A 137, 355 (1998); M. Doi and S. F. Edwards, The Theory of Polymer Dynamics, Oxford Science Publications, Walton Street, Oxford OX2 6DP, 1986, 1^{st}. ed.). The dilute to semi-dilute transition is defined at the minimum overlap concentration, when the average volume occupied by each rod approaches v*=1/L³ where L is the rod length. The semi-dilute to concentrated transition is defined when the volume occupied by each particle approaches the excluded volume of the particle. The excluded volume of a rod is defined as the volume around a point in the rod which typically does not contain the corresponding point in another such rod, due to purely geometrical constraints (L. Onsager, Ann. N.Y. Acad. Sci. 51, 627 (1949)). The excluded volume for an isotropic distribution of long and thin rods is described, to a good approximation, as v_{excl}≈L²r, where r is the rod radius. Simulations have shown that, for non-interacting rods, the percolation threshold is inversely proportional to the excluded volume of the rods, and in the case of long and thin rods, the proportionality becomes an equality (I. Balberg, C. H. Anderson, S. Alexander, and N. Wagner, Phys. Rev. B 30, 3933 (1984); I. Balberg, N. Binenbaum, and N. Wagner, Phys. Rev. Lett. 52, 1465 (1984); A. L. R. Bug, S. A. Safran, and I. Webman, Phys. Rev. Lett. 54, 1412 (1985)). On the other hand, aggregating systems are known to have lower thresholds than those predicted for non-interacting particles. In homogeneous distributions of strongly aggregating rodlike particles there is a lower-bound to the percolation threshold at the minimum overlap concentration (A. M. Wierenga and A. P. Philipse, Colloids and Surfaces A 137, 355 (1998); F. Carmona, F. Barreau, P. Delhaes, and R. Canet, Phys. Paris Lett. 41, L (1980); F. Carmona, P. Prudhon, and F. Barreau, Solid State Commun. 51, 255 (1984)), where the average volume occupied by a particle is v*=1/L³. In inhomogeneous systems composed of long chains of rods and large voids, the threshold concentration can be much lower, such as in the case of a single long chain spanning the length of the sample. Unfortunately, concepts such as concentration regimes do not apply to inhomogeneous systems. It is not clear whether a process that results in more anisotropic chain growth than in the homogeneous case provides a system that percolates below the overlap concentration. Thus, there is also a continuing need to understand how process conditions affect the anisotropy of chain growth in strongly aggregating systems of long rods such as SWNTs in nanotube composites.

### SUMMARY OF THE INVENTION

The present inventors have now developed methods for preparing electrically conductive carbon nanotube composite materials at nanotube concentrations lower than previously available. Accordingly, in various aspects of the present invention there are provided methods that include providing a dispersion comprising carbon nanotubes and a fluid medium, contacting the dispersion with a hardenable resin material to form a mixture, sonicating the mixture, and hardening the resin material.

The present inventors have also developed electrically conductive carbon nanotube composite materials at nanotube concentrations lower than previously available. Accordingly, in another aspect of the present invention there are provided compositions that include a matrix material and SWNTs having a weight fraction, relative to the matrix material, in the range of from about 0.0001 to less than 0.005, the compositions having an electrical conductivity greater than about 10⁻⁹ S/cm. In related aspects of the present invention there are provided compositions that include a matrix material and non-functionalized SWNTs having a weight fraction, relative to the matrix material, in the range of from about 0.0001 to less than 0.0074, the compositions having an electrical conductivity greater than about 10⁻⁹ S/cm. Also, the present invention provides compositions that include a crosslinked matrix material and SWNTs having a weight fraction, relative to the crosslinked matrix material, in the range of from about 0.0001 to less than 0.0074, the compositions having an electrical conductivity greater than about 10⁻⁹ S/cm. And, further aspects of the invention provide compositions that include a matrix material and SWNTs in the semi-dilute concentration regime, the compositions having an electrical conductivity greater than about 10⁻⁹ S/cm.

The present invention also provides electrical components that include a matrix material, and SWNTs near the percolation threshold, the electrical components having an electrical conductivity greater than about 10⁻⁹ S/cm. Within additional aspects of the present invention there are provided methods that provide a composition comprising a matrix material and nanotubes near the percolation threshold and thermally control nanotube network formation within the matrix material.

Other aspects of the present invention will be apparent to those skilled in the art in view of the detailed description of the invention as provided herein.

### BRIEF DESCRIPTION OF THE DRAWINGS

The foregoing summary, as well as the following detailed description, is further understood when read in conjunction with the appended drawings. For the purpose of illustrating the invention, there is shown in the drawings exemplary embodiments of the invention; however, the invention is not limited to the specific methods, compositions, and devices disclosed. In the drawings:

FIG. 1: (a1), (b1) and (c) show transmitted light microphotographs of ˜300 μm thick slices of composites. (a2) and (a3) are SEM images of fractured sections of the composites. The SWNT concentration is 2.0×10⁻⁴ in all images. (a1) Non-sonicured sample reveals inhomogeneities, possibly due to shear forces applied to it during cross linking and DMF evaporation. (a2) An inhomogeneous distribution of nanotube bundles in the non-sonicured sample confirms the observation of (a1). In this image, nanotubes are apparent in the lower left hand corner of the field of view. (b1) and (b2) Sonicured sample shows a homogeneous dispersion of nanotubes. (c) Non-sonicured sample made from a poor initial dispersion at 0.04 wt % of SWNTs in DMF reveals dense aggregates which failed to break up. (d) Photograph of sample mounted for four-point conductivity measurement. (e) Photographs of composites: diameter of composite cylinders is 4.7 mm; nanotube concentrations, from top to bottom, are 2.5×10⁻⁵, 4.9×10⁻⁵, 9.8×10⁵, and 1.5×10⁻⁴.

FIG. 2 depicts sample conductivity as a function of nanotube concentration for non-sonicured LMNT, sonicured LMNT, and non-sonicured HiPCO samples, respectively. The vertical lines on the charts indicate the predicted threshold concentrations according to L³ (wavy) and excluded volume (straight). Filled circles represent conductivities obtained from linear fits to I-V curves obtained using the four point method. Open circles represent conductivities obtained with two point alternating bias measurements. Both techniques are described in the examples. Shaded areas represent measurements below the reliability baseline for the setup.

### DETAILED DESCRIPTION OF ILLUSTRATIVE EMBODIMENTS

The present invention may be understood more readily by reference to the following detailed description of the invention taken in connection with the accompanying figures and examples, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. All ranges are inclusive and combinable. When such a range is expressed, another embodiment includes from the one particular value and/or to the other particular value. Similarly, when values are expressed as approximations, by use of the antecedent “about,” it will be understood that the particular value forms another embodiment.

In one embodiment of the present invention there are methods that include providing a dispersion having carbon nanotubes and a fluid medium, contacting the dispersion with a hardenable resin material to form a mixture, sonicating the mixture, and hardening the resin material. Suitable dispersions having carbon nanotubes and a fluid medium can include any combination of carbon nanotubes and fluid medium. The term “carbon nanotubes” is used herein to refer to the broad class of tube-shaped carbon-based compounds having diameters of less than about 50 nanometers (“nm”), typically less than about 40 nm, more typically less than about 30 nm, even more typically less than about 30 nm, further typically less than about 20 nm, even further typically less than about 10 nm, even more typically less than about 5 nm, even further typically less than about 2 nm, and even more typically less than about 1.5 nm. Carbon nanotube lengths vary broadly, from about 10 nm to more than 1000 nm. Suitable carbon nanotubes are typically at least about 100 nm long, more typically at least about 200 nm long, even more typically at least about 300 nm long, even further typically at least about 400 nm long, and yet further typically at least about 500 nm long. As use herein, nanotube dimensions refer to a statistical average of the dimensions of a statistically significant plurality of nanotubes.

Any type of carbon nanotube is suitably dispersed with a fluid medium. Although not an exhaustive listing of all known types of carbon nanotubes that can be used, a number of suitable carbon nanotubes that can be used in various embodiments of the present invention include the following: single-wall carbon nanotubes, multi-wall carbon nanotubes, armchair carbon nanotubes, zigzag carbon nanotubes, chiral carbon nanotubes, carbon nanofibers, carbon nanotoroids, branched nanotubes (e.g., as disclosed in U.S. Pat. No. 6,322,713, the details pertaining to the preparation branched nanotubes is incorporated by reference herein), carbon nanotube “knees”, coiled carbon nanotubes (L. P. Biro et al., Mat. Sci. and Eng. C 19 (2002) 3-7), or any combination thereof. Many types of carbon nanotubes are commercially available. Several procedures known in the art are capable of synthesizing a variety of carbon nanotubes. For example, multi-wall carbon nanotubes can be made by the arc method known in the art and SNWTs can be made by the high-pressure carbon monoxide (“HiPCO”) method known in the art and supplied commercially by Carbon Nanotechnologies, Inc. (Houston, Tex.). SNWTs can be synthesized by the laser-oven method and supplied commercially by Tubes@Rice (Rice University, Houston, Tex.). Carbon nanotoroids can be made by the HiPCO and laser-oven methods. Branched nanotubes can be made according to U.S. Pat. No. 6,322,713, the details pertaining to the preparation of branched nanotubes is incorporated by reference herein. Carbon nanofibers are commercially available from Electrovac GesembH, Klosterneuberg, Austria. Carbon nanofibers typically are hundreds of micrometers long having diameters from about 70 to about 500 nm, having greater than about 100 square meters per gram (m2/g) active chemical surface area. Chemical vapor deposition (CVD) methods are also capable of synthesizing carbon nanotubes.

While the carbon nanotubes that are useful in the present invention have mostly carbon atoms, it is envisioned that at least a portion of the carbon atoms may be substituted with any of a variety of non-carbon atoms. Likewise, while chemical modification of the carbon nanotubes is not typically required for practicing the present invention as described herein, nevertheless, the carbon nanotubes may be chemically modified for use in certain embodiments of the present invention. In this regard, chemical modifications may include functionalization with any of a variety of chemical functional groups and molecules as known and practiced in the nanotube art.

Any of the aforesaid nanotubes are readily incorporated in the methods, materials and devices of the present invention. Suitable carbon nanotubes typically comprise SWNTs, MWNTs, or any combination thereof, of which SWNTs are preferably used. Typically, the carbon nanotubes are unfunctionalized. In certain embodiments, the carbon nanotubes typically comprise greater than about 50 weight percent SWNTs. More typically, the carbon nanotubes comprise greater than about 95 weight percent SWNTs.

As used herein, the term “fluid” refers to the thermodynamic state of matter exhibited in the liquid state, gaseous state, or the supercritical state. Preferred fluids used in certain embodiments of the present invention are liquids. Suitable liquid fluids can be aqueous or non-aqueous for preparing suitable nanotube dispersions. A variety of methods for preparing aqueous nanotubes dispersions are know in the art, and include, for example, PCT/US03/16086, “Carbon Nanotubes: High Solids Dispersions and Nematic Gels Thereof”, the entirety of which is incorporated by reference thereto.

Suitable non-aqueous liquid fluids include any of the organic liquid solvents known for dispersing nanotubes. Combinations of aqueous and organic liquid fluids can also be used, for example, a miscible mixture of a water-soluble organic solvent (e.g. and alcohol) with water. In certain embodiments, the fluid medium typically includes a solvent that is characterized as being compatible, and preferably miscible, with the hardenable resin material. Suitable organic solvents used in the present invention have a wide range of thermal and physical properties. Preferably, suitable organic solvents have a normal boiling point temperature in the range of from about 100° C. to about 250° C. Typically, suitable organic solvents are capable of solubilizing, dispersing, or suspending individual carbon nanotubes, carbon nanotube bundles, carbon nanotube ropes, or any combination thereof. In this regard, suitable organic solvents typically include an alkane group, an aromatic group, a halogen atom, a nitrogen atom, a sulfur atom, an oxygen atom, or any combination thereof. In certain preferred embodiments, the organic solvent includes dimethyl formamide (“DMF”), toluene, xylene, dichlorobenzene, trichlorobenzene, or any combination thereof. Although liquids that are miscible with the hardenable resin material are generally preferred in many embodiments of the methods of the present invention, certain embodiments can utilize nanotube dispersions containing liquids that are incompatible with the hardenable resin material. As used herein, the term “compatible with the hardenable resin material” refers to the compatibility of polymers (e.g., resins) and solvents with regard to polymer-solution thermodynamics. Compatible solvents include those that swell, soften, or are at least partially miscible with the polymer or resin. Many combinations of polymers and solvents that are compatible (i.e., a solvent for the polymer) and incompatible (i.e., a non-solvent for the polymer) are provided in Polymer Handbook, 3rd Edition, Brandrup and Immergut, Eds., Wiley Interscience, New York, (1989), Chapter VII, “Solution Properties”, the entirety of which is incorporated by reference herein.

In certain embodiments, it is preferred that the fluid is capable of suspending individual carbon nanotubes. Suitable fluids for suspending individual carbon nanotubes include dimethylformamide, toluene, tetrahydronaphthalene, decalin, dichlorobenzene, as well as any combination thereof.

Suitable nanotube-fluid dispersions that are used in certain embodiments of the methods of the present invention are typically characterized as being homogeneous or heterogeneous. Suitable homogeneous nanotube dispersions are typically characterized as fluids having substantially no particles visible to the unaided eye. Typical homogeneous dispersions include individual carbon nanotubes, aggregates of fewer than about 10 carbon nanotubes, or both, that are evenly dispersed throughout the fluid. Other embodiments of the present invention make use of homogeneous nanotube dispersions that are substantially free of carbon nanotube agglomerates. As used herein, the term “substantially free of carbon nanotube agglomerates” means that a small amount of carbon nanotube agglomerates may be present in the dispersion as long as the that amount does not affect the properties of the dispersion.

While almost any concentration of nanotubes in the dispersions may be used, suitable dispersions of certain embodiments typically have up to about 1.0 weight percent of carbon nanotubes, based on total weight of the dispersion. Various embodiments of the present invention use dispersions having nanotube concentrations much lower than 1.0 weight percent. For example, suitable dispersions have at least about 0.0001, more suitably at least about 0.001, and even more suitably at least about 0.01 weight percent of carbon nanotubes, based on total weight of the dispersion. In certain embodiments, the concentration of nanotubes is preferably not more than about 0.1 weight percent of carbon nanotubes, based on total weight of the dispersion. In other embodiments, the concentration of nanotubes is preferably in the range of from about 0.003 to about 0.03 weight percent of carbon nanotubes, based on total weight of the dispersion.

Suitable hardenable resin materials used in the present invention typically include a resin that can be cured, annealed, glassified, ordered, crystallized, crosslinked, or any combination thereof. Suitable hardenable resin materials include virtually any type of polymeric material, resin-forming precursor, or any combination thereof. Suitable hardenable resin materials are typically capable of comprising a soft condensed matter state throughout which a dispersion of carbon nanotubes can be formed, and subsequently hardened. For example, in one embodiment, liquid epoxy precursors are characterized as being in a soft condensed matter state. Thus, liquid epoxy precursors may be mixed with a nanotube dispersion, and then the precursors are then cured (i.e., hardened) to form a solid material. In another embodiment, polymers in the liquid or viscoelastic state (i.e., above the glass transition temperature and/or crystalline melt transition temperature) are characterized as soft condensed matter that can be mixed with a nanotube dispersion, and then hardened by cooling to form a solid material. In other embodiments, polymers that are hard can be made into a soft condensed matter state by application of heat, by dissolution or dispersion in a fluid (e.g., an emulsion or suspension of polymer particles), or both. Such dissolved or dispersed polymers can be mixed with a suitable nanotube dispersion and then hardened by cooling, removal of fluid, or both. Suitable hard polymers include any of the known polymeric materials, such as thermoplastic resins.

Suitable polymeric materials include thermoplastic resins and thermoplastic elastomers. Suitable resin-forming precursors include any type of chemical composition that can undergo a linking reaction (e.g., a chemical reaction) with itself or with other compounds. Examples of resin-forming precursors include monomers (which can undergo a polymerization linking reaction), oligomers, and reactive polymers, such as thermosetting resins, crosslinkable rubber precursors, and radiation curable resins.

Suitable thermosetting resin includes epoxy resins, polyimides, bis-maleimide resins, benzocyclobutenes, phenol resins, unsaturated polyesters, diallyl phthalates, silicone resins, polyurethanes, polyimide silicones, thermosetting polyphenylene ether resins, modified PPE resins, as well as any combination thereof.

Suitable crosslinkable rubber precursors and analogues thereof include precursors of the following: natural rubbers, butadiene rubbers, isoprene rubbers, styrene-butadiene copolymer rubbers, nitrile rubbers, hydrogenated nitrile rubbers, chloroprene rubbers, ethylene-propylene rubbers, chlorinated polyethylenes, chlorosulfonated polyethylenes, butyl rubbers, butyl rubber halides, fluorinated rubbers, urethane rubbers, and silicone rubbers.

Suitable radiation-curable resins include a combination of one or more of polymers, oligomers, and monomers that are ionizing radiation curable, such as acrylates and methacrylates, radical-polymerizable compounds, and materials having as a base an oligomer and/or monomer of a cation-polymerizable compounds and having blended therewith an additive for purpose of curing such as ultraviolet ray polymerization initiator, such as a photo acid generator (“PAG”).

While any thermoplastic resin may be used in various embodiments of the present invention, suitable thermoplastic resins typically include at least one of, or any combination of two or more of the following: polyolefins, such as polyethylene, polypropylene, and ethylene α-olefin copolymers such as ethylene-propylene copolymer, polymethylpentene; halogenated polymers such as polyvinyl chloride, polyvinylidene chloride; polyvinyl acetate, ethylene vinyl acetate copolymers, polyvinyl alcohol, polyacetal; fluororesins such as polyvinylidene fluoride and polytetrafluoroethylene; polyesters such as polyethylene terephthalate, polybutylene terephthalate, and polyethylene naphthalate; styrenic polymers such as polystyrenes, polyacrylonitriles, styrene acrylonitrile copolymers, and ABS resins; polyphenylene ether (PPE) and modified PPE resin, aliphatic and aromatic polyamides, such as nylons, polyimides, polyamide imides; polymers and copolymers derived from units consisting of one or more C₁-C₂₀ n-alkyl acrylate and methacrylate monomers, such as polymethacrylic acid and polymethacrylates such as polymethyl methacrylate, polyacrylic acids; polycarbonates, polyphenylene sulfides, polysulfones, polyether sulfones, polyether nitriles, polyether ketones, polyketones, liquid crystal polymers, silicone resins, ionomers, as well as blends, blocks, grafts, and alloys thereof.

Suitable thermoplastic elastomers include styrene-butadiene or styrene-isoprene block copolymers and hydrogenated polymers thereof, styrene thermoplastic elastomers, olefin thermoplastic elastomers, vinyl chloride thermoplastic elastomers, polyester thermoplastic elastomers, polyurethane thermoplastic elastomers, acrylic thermoplastic elastomers, polyamide thermoplastic elastomers, as well as any combination thereof.

Contacting of nanotube dispersions and hardenable resin materials to form a mixture typically includes bringing the components together in a suitable container, pipe, conduit, reaction zone, or on a surface or film, or dispersed as particles or molecules in a vacuum or fluid media. The contacting typically allows the nanotubes to diffuse and intermingle with the hardenable resin components. A suitable form of contacting in certain embodiments includes mixing. In certain embodiments the contacting method may include shear mixing. Typically the nanotubes are permitted to become randomly oriented under the influence of Brownian motion in the mixture. Thus, in several embodiments, a certain amount of shear mixing of the components in a suitable container is permissible, which may orient the nanotubes, and then the shearing is stopped to allow the nanotubes to become randomly oriented. In certain embodiment, shear mixing is applied using a shear field to effect efficient intermingling (i.e., mixing) of the component nanotubes, fluid, and hardenable resin material. Suitable containers include reactors, kettles, beakers, drums, tubes and pipes. Suitable shear fields can be applied using a moving surface, a mixing blade, or any other type of impeller known in the art. Use of a shear field is not required in certain embodiments in which the mixture has a low viscosity (e.g., the mixture readily flows as fluid). In preferred embodiments, shear mixing is minimized and intermingling of the nanotubes and hardenable resin components is effected primarily by diffusion and sonication.

Suitable sonicating conditions can be provided using any of a number of commercially available sonicating equipment. Suitable sonicators include bath sonicators, probe sonicators, tip sonicators, and cup-horn sonicators. The operating characteristics of examples of different types of sonicators is provide in Table I.

TABLE I
Sonicator Types, Frequency Ranges, Acoustic Power Ranges (W/cm²)

| | Typical Frequency Range | Typical Power density |
|---|---|---|
| Sonicator Type | (KHz) | (Watts/cm²) |
| Bath | 20 to 100 | 0.01 to 2 |
| Probe | 500 to 3000 | 1 to 1000 |
| Tip | 20 to 40 | 1 to 50 |
| Cup-Horn | 20 to 40 | 100 to 1000 |

Sonication of the mixture is typically carried out at a suitable frequency and acoustic power to maintain the nanotubes dispersed in the mixture. The sonicating frequency is typically in the range of from about 1 KHz to about 10,000 KHz, more typically in the range of from about 20 KHz to about 6,000 KHz, and even more typically in the range of from about 20 KHz to about 200 KHz. Suitable sonicating power varies with the volume of the mixture that is being sonicated. Sonicating power can also be varied and is typically expressed in terms of acoustic power, which is measured in units of unit power per unit area (e.g., W/cm²). As an example, a one pint mixture is typically sonicated using a power in the range of from about 10 to 200 watts. Different mixture volumes typically require differing sonication power that scales with mixture volume. A suitable acoustic power is typically in the range of from 0.01 W/cm² to 1000 W/cm², more typically in the range of from about 0.01 W/cm² to 50 W/cm², and even more typically in the range of from about 0.01 W/cm² to 2 W/cm².

In certain embodiments of the present invention there are provided methods that further include removing at least a portion of the fluid medium from the mixture while sonicating. Removing at least a portion of the fluid medium while sonicating is typically carried out under conditions of allowing the fluid medium to evaporate. Sonicating typically adds energy to the mixture, which in open systems, may contribute to the evaporation of at least a portion of the fluid medium. Evaporation of the fluid medium may also be effected by heating the mixture, by subjecting the mixture to a lower pressure (e.g., under a vacuum), or any combination thereof. Evaporation of the fluid medium may be conducted before sonicating has begun, during sonicating, after sonicating has been halted, or any combination thereof. In certain preferred embodiments it is desirable that substantially all of the fluid medium is removed. By “substantially all of the fluid medium is removed” means that a small amount of fluid medium that may reside within the mixture does not affect the properties of the resulting composite material.

The components can be mixed in a variety of ways. In one embodiment the contacting includes flowing the dispersion into the hardenable resin material, the hardenable resin material residing within a container while sonicating the contents of the container to form a mixture. Suitable containers are capable of containing the mixture. Suitable containers can be placed in a sonicating bath, a sonicator may be placed in a suitable container, or both. Suitable containers typically include flasks, vials, tubes, drums, reaction vessels, as well as combinations thereof.

In another embodiment there is a method of preparing a nanotube composite material in which the hardenable resin material is a curable resin. In this embodiment, the method may further include contacting the fluid medium, dispersion, hardenable resin material, mixture, or any combination thereof, with a curing agent. Suitable curing agents are readily available in the polymeric materials art. Many suitable curing agents are commercially available in liquid form. Suitable examples of curing agents include those activated by visible light, ultraviolet light, heat, radiation, or any combination thereof. The timing of the addition of the curing agent influences the kinetics of the curing of the curable resin and the resulting morphology of the nanotube composite. Thus, in certain embodiments, it is desirable that the contacting with the curing agent occurs at least prior to sonicating the mixture. In other embodiments the contacting with the curing agent occurs after sonicating has begun. Likewise, the timing of the removal of at least a portion of the fluid can influence the kinetics of the curing of the curable resin. The timing of the removal of at least a portion of the fluid can also influence the resulting morphology of the nanotube composite. Thus, in certain embodiments that include the addition of a curing agent, at least a portion of the fluid medium can be removed from the mixture while sonicating. Preferably, substantially all of the fluid medium is removed so that traces of the residual fluid have essentially no effect on the resulting properties of the nanotube composites. The fluid medium is typically removed by evaporation. In certain embodiments that include the contacting of the mixture with a curing agent, this contacting occurs after substantially all of the fluid medium is removed.

In several embodiments, hardening the resin material typically includes curing, glassification, ordering, crystallization, or any combination thereof. Curing typically occurs in thermosetting resin systems, for example in reactive epoxy, vinyl ester, and polyurethane reactive composite precursors. Glassification typically occurs in materials that are cooled below their glass transition temperature. Examples of hardenable resin materials that are capable of glassification include acrylic and styrenic polymers. Ordering typically occurs in amphiphilic systems, such as block copolymers, wherein the differing polymer blocks attempt to segregate from each other from a softer disordered state to form ordered structures that typically have increased stiffness. Crystallization typically occurs in polymers having a portion that is characterized as isotactic or syndiotactic. Crystallizable polymers typically harden upon cooling below their crystalline melt transition temperature. In various of these embodiments, solvent may optionally be present as the resin hardens.

In certain preferred embodiments, this hardening of the resin material typically begins after the sonicating has begun, although the resin may begin to harden before sonicating. For example, in certain embodiments, it may be desirable to allow the resin to harden less than required to form a solid. Hardening before sonicating may also be desirable in certain embodiments for controlling viscosity. Hardening before sonicating may also be desirable in certain embodiments for controlling morphology, for example, to provide resinous microdomains, nanodomains, or both in the composites. The point at which the sonicating is halted can vary depending on the desired morphology of the dispersed nanotubes in the resulting matrix. In certain embodiments where the hardenable resin forms a physically tough substance, such as in an engineering composite resin, the hardening typically continues well after the sonicating has stopped. In other embodiments, the hardening typically continues even after the sonicating stops. Other embodiments permit the sonicating to stop while the nanotubes are still somewhat mobile to control agglomeration, aggregation, or both, of the dispersed nanotubes in the matrix.

In one embodiment of the present invention there are provided methods that include providing a dispersion having carbon nanotubes and a fluid medium, mixing the dispersion with a thermally-curable or radiation-curable resin to form a mixture, sonicating the mixture, and hardening the resin material. Suitable thermally-curable resins include an epoxy resin, a polyester resin, an acrylic resin, a polyimide resin, or any combination thereof. In certain embodiments, the curable resin is at least partially uncured during mixing with the dispersion, and in preferred embodiments the curable resin remains substantially uncured during mixing with the dispersion.

Various embodiments of the present invention also provide for compositions comprising at least nanotubes and a matrix material. Such materials can be made according to the general procedures provided herein. In one embodiment, for example, there are provided compositions that include a matrix material and SWNTs, wherein the compositions have an electrical conductivity greater than about 10⁻⁹ S/cm. In these embodiments, the SWNTs typically have a weight fraction, relative to the matrix material, in the range of from about 0.0001 to less than 0.005. More typically, the SWNTs have a weight fraction of at least about 0.0002, even more typically at least about 0.0005 weight percent, further typically at least about 0.001 weight percent, and even further typically at least about 0.002 weight percent. Typically, the concentration is such that the SWNTs are in the semi-dilute regime.

Increasing conductivity at low nanotube weight fraction is typically obtained using single SWNTs. Thus, in certain embodiments, the SWNTs typically comprise greater than about 50 percent by weight of single SWNTs. The characteristics of the dispersion of the nanotubes in the matrix material also affects electrical conductivity. One dispersion characteristic is homogeneity, thus certain embodiments of the present invention provide for matrix materials having homogeneously dispersed SWNTs, whereas other embodiments allow for slight heterogeneity of the SWNTs to control the properties of the composition. Thus, several embodiments of the present invention include SWNTs that are inhomogeneously dispersed in the matrix material as well.

In various embodiments of the electrically conductive compositions of the present invention, it is preferred that the nanotubes are not functionalized. Thus, in certain embodiments of the present invention, there are provided compositions that include a matrix material, and non-functionalized SWNTs having a weight fraction, relative to the matrix material, in the range of from about 0.0001 to less than 0.0074, the composition having an electrical conductivity greater than about 10⁻⁹ S/cm.

In various embodiments of the electrically conductive compositions of the present invention it is preferred that the matrix material is crosslinked. Thus, in certain embodiments of the present invention, there are provided compositions that include a crosslinked matrix material and SWNTs having a weight fraction, relative to the crosslinked matrix material, in the range of from about 0.0001 to less than 0.0074, the composition having an electrical conductivity greater than about 10⁻⁹ S/cm.

In various embodiments of the electrically conductive compositions of the present invention it is preferred that the nanotubes are in the semi-dilute regime. As used herein, the term “semi-dilute regime” refers to the concentration regime in which nanotubes in the matrix materials just begin to overlap. Thus, in certain embodiments of the present invention, there are provided compositions that include a matrix material and nanotubes in the semi-dilute concentration regime, the composition having an electrical conductivity greater than about 10⁻⁹ S/cm. Typically, the concentration of the SWNTs is above the percolation threshold. Suitable matrix materials may be conductive, semi-conductive, non-conductive, or a combination thereof. Matrix materials are typically non-conductive. Suitable matrix materials have electrical conductivities typically less than about 10⁻¹⁰ S/cm, more typically less than about 10⁻¹¹ S/cm, even more typically less than about 10⁻¹² S/cm, further typically less than about 10⁻¹³ S/cm, even further typically less than about 10⁻¹⁴ S/cm, and still further typically less than about 10⁻¹⁵ S/cm. Suitable examples of non-conductive matrix materials include any of the materials described herein as a hardenable resin material. Ceramics, sol-gel materials, and cermet materials are also suitable matrix materials.

Certain embodiments of the present invention also provide for electrical components that can be made using the various electrically conductive compositions provided herein. Thus, in certain embodiments, there are provided electrical components that include a matrix material and SWNTs in the semi-dilute concentration regime, the electrical component having an electrical conductivity greater than about 10⁻⁹ S/cm. Suitable electrical components include fuses, transistors, resistors, thermistors, sensors, capacitors, conductors, diodes, or any combination thereof. For example, fuses can be prepared from nanotube composites near the percolation threshold. Without being bound by a particular theory of operation, current-induced heating of a nanotube composite breaks the nanotube percolating network and reduces or halts the current conduction. Accordingly, thermal control of the percolation threshold in nanotube composite materials is also provided. Thus, in several embodiments, there are provided methods that include a composition comprising a matrix material and nanotubes near the percolation threshold, and thermally controlling nanotube network formation within the matrix material. Thermal control of the SWNT network is typically provided when the concentration of nanotubes in the matrix material is within the semi-dilute regime. Thermal control of the SWNT network can also be provided at various temperature ranges for use in different temperature-dependent electrical applications, such as fuses, thermistors and temperature sensors. Accordingly, thermally-induced percolation can be controlled, for example in one embodiment, by preparing nanotube composites at the percolation threshold at the hardening temperature. Without being bound to a particular theory of operation, subsequent heating of the nanotube composite above the hardening temperature results in expansion of the matrix material, which breaks the nanotube network, and reduces or halts the flow of electrical current. Subsequent cooling of the nanotube composite causes the matrix to shrink and reestablish the nanotube network.

Suitable fuses that can be made according to embodiments of the present invention include resettable fuses. Resettable fuses include devices with a large Positive Temperature Coefficient (PTC) or positive temperature resistivity coefficient (α). The temperature-dependent resistivity of such fuses can be described by the formula ρ=ρ₀(1+αT and βT²), where ρ is the temperature-dependent resistivity, T is temperature, ρ₀ is a reference resistivity at T=0, and α and β are temperature resistivity coefficients. Suitable resettable fuses under normal operating conditions (i.e., the conducting state) exhibit a substantial amount of overlap of the nanotubes that gives rise to many possible electrical paths and thus low resistance. Under a fault condition (i.e., the non-conducting state), excessive current causes suitable resettable fuses to heat and expand to such an extent that overlap of the nanotubes decreases substantially. The number of electrical pathways reduces considerably, and thus the resistance increases considerably under a fault condition. When the device cools down when the fault is removed, overlap of the carbon nanotubes is reestablished and electrical current through the resettable fuse resumes. Suitable resettable fuses can be cut from large sheets of metal coated composite materials. For example, a product in sheet form can include the following materials: an inner layer including a composite material of polymer and SWNTs; and two conductive metal outer layers, for example, nickel foil. Suitable products can be provided as a sheet, for example 12 by 16 inches (30 by 40 cm), with layer thicknesses of Inner layer: 0.3 mm and each outer metal layer: 0.025 mm. Further details pertaining to the fabrication of resettable fuses are provided in U.S. Pat. No. 4,545,926, to Fouts, Jr., et al., the entirety of which pertaining to the fabrication and design of resettable fuses is incorporated by reference herein.

Applications for resettable fuses include surge protectors, lightning protection circuitry, various electrolytic cells such as lithium ion cells, battery packs, computer PC cards, automotive wire harnesses, and network equipment. Suitable design specifications vary with application, but generally can be varied as follows:

Maximum constant current without tripping switch at room temperature—0.05 to 15 A

Minimum current needed to trip device—0.1 to 28 A

Maximum current through device that does not destroy the device—3 to 100 A

Maximum operating voltage—6V to 250V

Time to trip (s)—0.02 to 60

Minimum device resistance—0.0022 to 15 ohms

Actual resistance of device will vary from one piece to another, device may not return to same resistance after being tripped.

Maximum device resistance after being tripped and returned to original state—0.0064 to 50 ohms.

In certain embodiments, the nanotube concentration is provided so that the nanotube network is above the percolation threshold at temperatures below about 25° C. Other embodiments provide nanotube composites that undergo a percolation transition at almost any temperature that the composite can withstand. For example, suitable percolation transition temperatures can be designed to be below about 100° C., or even below about 200° C., or even below about 300° C. in the nanotube composite materials according to various embodiments of the present invention. Likewise, the concentration of nanotubes can be below the percolation threshold when the temperature is above about 50° C., or above about 100° C., or above about 200° C. In certain embodiments, the percolation transition temperature can be above about 300° C.

### EXAMPLES

Several examples provide methods for making SWNT in epoxy composites that allow the dispersion characteristics to be controlled from homogeneously distributed SWNT ropes, to diffuse agglomerates, and to dense aggregates. In these examples, two types of highly purified and well characterized nanotubes with different mean lengths were used. The two types of nanotubes used in this study were laser oven tubes (LMNT) (Tubes@Rice, batch P08160042) and HiPCO tubes (Carbon Nanotechnologies, Inc., batch 79). The nanotubes were obtained in raw form from and purified according to procedures essentially described in the following references: A. G. Rinzler, J. Liu, H. Dai, P. Nikolaev, C. B. Huffman, F. J. Rodriguez-Marcias, P. J. Boul, A. H. Lu, D. Heyman, D. T. Colbert, et al., Appl. Phys. A 67 29 (1998); J. H. Hafner, M. J. Bronikowski, B. R. Ajamian, P. Nikolaev, A. G. Rinzler, D. T. Colbert, K. A. Smith, and R. E. Smalley, Chem. Phys. Lett. 296, 195 (1998)). The tubes were magnetically fractionated to reduce the magnetic catalyst fraction to less than about 0.7 wt % and annealed at 1150° C. A combination of x-ray and thermogravimetric analysis (TGA) measurements showed that the resulting purified nanotubes contained greater than about 95 wt % SWNTs and less than about 5 wt % carbon-derivative (amorphous carbon, graphite) impurities in addition to the above-mentioned small quantities of catalyst particles. The laser oven nanotube sample had an average SWNT length, L, of about 516±286 nm and an average diameter of about 1.35±0.15 nm (M. F. Islam, E. Rojas, D. M. Bergey, A. T. Johnson, and A. G. Yodh, Nanoletters 3, 269 (2003)). HiPCO tubes had a length of 165+/−90 nm and a diameter of 1.1 nm±0.3 nm.

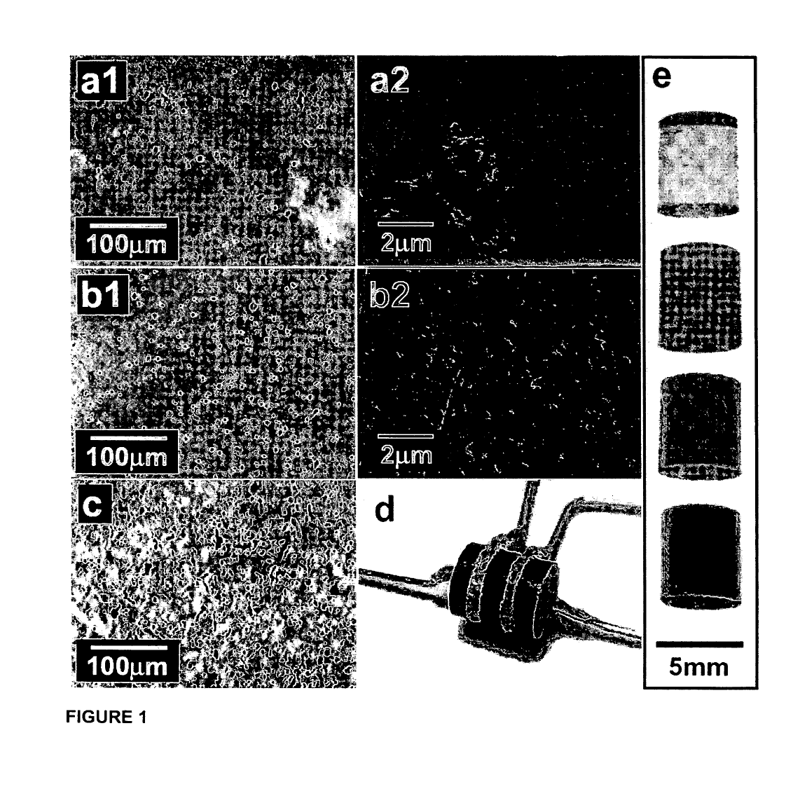

The nanotubes were dispersed in DMF at a concentration of 0.004 wt % and 0.04 wt % using a low power, high frequency sonicator. Height measurements using Atomic Force Microscopy (AFM) determined that the 0.004 wt % SWNT-DMF dispersion contained a mixture of isolated nanotubes and small bundles, whereas the 0.04 wt % SWNT-DMF dispersion contained small and large bundles. The thermoset epoxy resin was Shell Epon 828 (Bisphenol-A, Miller Stephenson) epoxy resin and EpiKure 3234 cross-linker (aliphatic amine, Miller Stephenson). For each SWNT-composite sample, 0.5 g of epoxy resin was weighed out in a ceramic crucible and placed in a low power, high frequency bath sonicator. The temperature of the bath sonicator was kept at 80° C. The SWNT-DMF suspension was added to the heated and sonicating epoxy resin with a glass syringe in discrete 1 ml increments every 45 minutes, until the desired nanotube concentration was reached. Without being bound by a theory of operation, it appears that the elevated sonication temperature reduces the viscosity of the epoxy resin, which assists in effective sonication and promotes faster DMF evaporation. After the final addition, the sample was sonicated for an additional 2-3 hours to evaporate the DMF. After this time, substantially no DMF was left in the sample, as confirmed by weighing the crucible. 65 μL of EpiKure 3234 cross-linker was added to the sonicating SWNT-epoxy resin mixture, mechanically stirred for two minutes, and loaded into a thin-walled cylindrical Teflon mold (inner diameter 4.7 mm). Samples were divided into two sets. In the first set, the samples were placed in a hot water bath at 90° C. for 30 min and curing proceeded without sonication. Hereafter, these samples are referred to as “non-sonicured” samples. In the second set, the mold was placed back into the sonicator bath at 80° C. and cured under sonication for 30 min. These samples are referred to as “sonicured” samples. Both sets of samples were then annealed in an oven at 120° C. for two hours. Photographs of several samples are shown in FIG. 1. Thus prepared, the samples were cut with a diamond saw into 5.4 mm, 2.5 mm and 300 μm long pieces, each piece having flat ends that were polished using 5 μm grain polishing paper. Transmitted light optical images of polished thin sections and SEM images of fractured surfaces of SWNT-composite pieces allowed a qualitative determination of the degree of nanotube dispersion in the composite.

Observations of the initial SWNT-concentration and curing-process-dependent are summarized in FIG. 1. Composite samples made with a 0.04 wt % SWNT-DMF suspension show dense nanotube aggregates, which are similar in appearance as the initial dispersion shown in FIG. 1c. These dense aggregates apparently do not break up when they are sonicated in the epoxy resin. On the other hand, FIG. 1a1 shows that composites made with well dispersed 0.004 wt % SWNT-DMF suspension show very few dense aggregates. Agglomeration of nanotubes is evident in nonsonicured samples, which is possibly induced by the shear applied to the sample while cross linker is added and DMF is evaporating. The distribution of nanotube agglomerates in the epoxy matrix is inhomogeneous, as seen in FIG. 1a1 and 1a2. In contrast to the dense aggregates, the agglomerates can be broken apart, and a more homogeneous dispersion of nanotubes can be obtained by continued sonication of the SWNT-epoxy resin after cross-linker addition, as shown in FIG. 1b1.

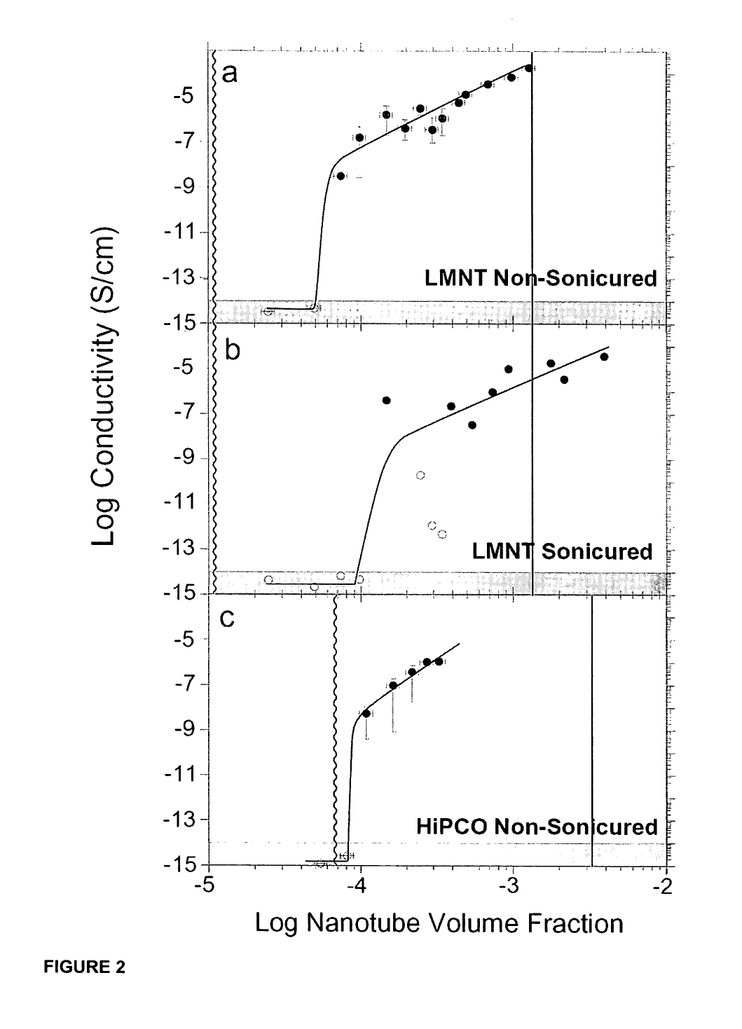

Composite conductivities were measured as follows. Two conductive rings having a spacing of approximately 1 mm were painted around the circumferences of the surfaces of cylindrical samples as shown in FIG. 1d. A known source current was applied between the two flat ends of the sample, and the voltage drop in the gap between the conductive ring contacts was recorded. I-V curves were obtained in the current range corresponding to a bias of ±5V as observed in the voltage-sourced two point measurements, and was different for each sample. Conductivities were determined from σ=mL=A, where m is the slope of current to voltage, A is the cross-sectional area of the sample, and L is either the length of the sample in two point measurements, or the width of the gap between the ring electrodes in the four point measurements. Samples with conductivities of less than 1×10⁻¹⁰ were measured by an alternating bias two point method, switching between positive and negative bias voltages and extracting the conductivity from the capacitative decay curves (Daire, A., “Improving the Repeatability of Ultra-High Resistance and Resistivity Measurements”, Keithly Instruments, Cleveland, Ohio, downloaded June, 2004 from http://www.keithley.com). The baseline for these measurements is approximately 1×10⁻¹⁴ S/cm, as indicated by the shaded gray areas in FIG. 2.

A comparison between two point and four point measurements reveals that the four point measurements result in a linear voltage to current dependence in the range measured, while two point measurements are distinctly non-linear. This indicates a bias-dependent contact resistance. For this reason, four-point measurements were performed on all samples. An aging effect was also observed in the samples. After a period of two months, conductivities of all samples were observed to decrease by approximately 50%. The conductivity was observed to recover to about 75%-100% of its original value after being placed in an oven at 110° C. for one hour and cooled to room temperature. Without being bound by a particular theory of operation, the cause for this decrease in sample conductivity seems to be independent of the nature of the contacts, since similar behavior was observed in four point measurements. Also, re-applying the conductive paint did not seem to affect the results.

The directional dependence of the conductivity was determined by cutting a SWNT composite sample into a cuboid of dimensions 3.5 mm×3 mm×2.1 mm. The conductivity was measured across all three dimensions. The conductivity for three directions was 3.4×10⁻⁸, 3.2×10⁻⁸, and 2.4×10⁻⁸. The two-point conductivity of the original cylindrical sample was 8.9×10⁻⁹. FIG. 2 shows the conductivity of the non-sonicured LMNT, sonicured LMNT, and non-sonicured HiPCO samples as a function of SWNT concentration. The data were fit to an equation of the form σα(p−p_{c})γ to extract the percolation-like critical exponent γ. Here, σ is the conductivity, p is the concentration, and p_{c} is the observed threshold concentration. Table II summarizes the positions of the observed thresholds and best fit critical exponent values above the threshold. The critical exponent for sonicured samples was fit to concentrations above 4×10⁻⁴ to eliminate the effects of noisy data below this concentration.

TABLE II
Table depicting the observed threshold concentrations, critical
exponents, and predicted thresholds for the three data sets.

| | | | HiPCO Non- |
|---|---|---|---|
| Composite Type | LMNT Non-sonicured | LMNT Sonicured | Sonicured |
| Observed Threshold | 6.5 × 10⁻⁵ | 7.3 × 10⁻⁵ to 9.8 × 10⁻⁵ | 8.9 × 10⁻⁵ |
| Critical Exponent | 2.01 +/− 0.23 | 2.6 +/− .8 | 2.22 +/− 0.11 |
| Nanotube Length | 516 +/− 286 nm | 516 +/− 286 nm | 165 +/− 90 nm |
| Nanotube Diameter | 1.35 +/− 0.15 nm | 1.35 +/− 0.15 nm | 1.1 +/− 0.3 nm |
| Overlap | 1 × 10⁻⁵ | 1 × 10⁻⁵ | 6.5 × 10⁻⁵ |
| Concentration | | | |
| Excluded Volume | 1.3 × 10⁻³ | 1.3 × 10⁻³ | 3 × 10⁻³ |
| Concentration | | | |

The observed threshold concentrations were compared to the theoretical minimum overlap and excluded volume concentration predictions. The concentration corresponding to the semi-dilute to concentrated transition, or the excluded volume, was 1.3×10⁻³ for the LMNT samples and 3.2×10⁻³ for the HiPCO samples. At the minimum overlap concentration, the average volume available to each rod can be described by a sphere V=(4/3)π(L/2)³ where L is the rod length. This corresponds to a SWNT concentration of 1.0×10⁻⁵ for the longer LMNT and 6.5×10⁻⁵ for the shorter HiPCO. As seen in FIG. 2, the thresholds that were observed fell within the semi-dilute concentration regime. Sonicured samples seemed to exhibit a higher threshold, which appears to be consistent with the interpretation that sonication reduces aggregation, shifting the system closer to the threshold expected for non-interacting rods. The conductivities of composites having nanotube concentrations lower than the minimum overlap concentration were all less than about 10⁻¹⁴ S/cm. While inhomogeneities are present in the non-sonicured samples, the threshold appears to remain within the semi-dilute regime. Without being bound by a particular theory of operation, the threshold does not appear to occur in the dilute regime, so it appears that the moderate shear applied to the samples did not result in significantly more anisotropic or “stretched” chains than would form in an equally strongly aggregating system without shear. Apparently side-to-side bundling and chaining gave rise to the observed inhomogeneities. Although the threshold concentration for the shorter HiPCO is higher then for the longer LMNT, HiPCO tubes percolate closer to their minimum overlap concentration than LMNT, which is possibly controlled by chain formation dynamics.

Percolation phenomena of hard rod systems was observed in several of the exemplary nanotube composites that were prepared using highly purified and well-dispersed nanotubes. The conductivity results of these examples were compared to theoretical predictions. These results indicate that conductive composites can be prepared using nanotube concentrations in the semi-dilute regime. The conductivity threshold appears to depend on the processing of the nanotube composite materials. For example, when aggregation is inhibited, such as in the sonicured composite examples, higher nanotube concentrations are apparently required. On the other hand, nanotube chaining in non-sonicured samples results in a lower observed threshold. Inhomogeneities in many of these samples apparently do not reduce the conductivity threshold below the minimum overlap concentration. Without being bound by a particular theory of operation, this result suggests that the inhomogeneities were formed by a redistribution of chains rather than more anisotropic chain growth. It was also observed that composites made using the higher aspect ratio LMNT nanotubes had a lower conductivity threshold compared to composites made using the shorter HiPCO nanotubes. In addition, the threshold for HiPCO was observed closer to the minimum overlap concentration.

Many of these examples demonstrate the formation of conductive networks in polymer composites using very low concentrations of SWNTs. Without being bound by a particular theory of operation, this behavior is attributed to the high aspect ratio of nanotubes and their tendency to form networks through aggregation. In certain embodiments, procedures for incorporating SWNTs into epoxy resins was developed. Several of these procedures enable the control of the dispersion quality of nanotubes in the composite—from homogeneously distributed small nanotube ropes, to diffuse agglomerates, to dense aggregates. Well characterized and purified SWNTs having different lengths were processed into electrically conductive composites. Carbon nanotube composites exhibited percolation-like conductivity with thresholds at volume fractions of below 7.3×10⁻⁵ to about 1.5×10⁻⁴. This appears to be the lowest threshold concentration seen in isotropic SWNT composites. The thresholds were observed in the semi-dilute regime, slightly above the minimum overlap concentration of the nanotubes in solution, with shorter nanotubes more closely approaching this concentration in several embodiments. Accordingly, several of these examples provide guidelines for making electrically dissipative nanotube composites as well as electrical components and devices made therefrom.

Methods, materials and devices containing low concentrations of carbon nanotubes have been provided. While the present invention has been described in connection with the exemplary embodiments of the various figures and examples, it is to be understood that other similar embodiments may be used or modifications and additions may be made to the described embodiment for performing the same function of the present invention without deviating therefrom. For example, one skilled in the art will recognize that the methods of the present invention as described in the present application may include, for example, additional processing steps. Likewise, the compositions of the present invention as described in the present application may include, for example, any type of matrix material. Therefore, the present invention should not be limited to any single embodiment, but rather should be construed in breadth and scope in accordance with the appended claims.

What is claimed:

1. A method, comprising:
providing a dispersion comprising carbon nanotubes and a fluid medium;
contacting said dispersion with a hardenable resin material to form a mixture;
sonicating said mixture; and
hardening said resin material.

2. The method of claim 1, wherein said hardenable resin material comprises a curable resin.

3. The method of claim 1, wherein said hardening comprises curing, glassification, ordering, crystallization, crosslinking, or any combination thereof.

4. The method of claim 1, wherein said hardening begins after said sonicating has begun.

5. The method of claim 1, wherein said hardening ends after said sonicating has stopped.

6. The method of claim 1, wherein said sonicating is characterized as having a frequency in the range of from 1 KHz to 10,000 KHz.

7. The method of claim 1, wherein said sonicating is characterized as having a frequency in the range of from 20 KHz to 6,000 KHz.

8. The method of claim 1, wherein said sonicating is characterized as having a frequency in the range of from 20 KHz to 200 KHz.

9. The method of claim 1, wherein said sonicating is characterized as having an acoustic power in the range of from 0.01 W/cm² to 1000 W/cm².

10. The method of claim 1, wherein said sonicating is characterized as having an acoustic power in the range of from 0.01 W/cm² to 50 W/cm².

11. The method of claim 1, wherein said sonicating is characterized as having an acoustic power in the range of from 0.01 W/cm² to 2 W/cm².

12. The method of claim 1, further comprising removing at least a portion of said fluid medium from said mixture while sonicating.

13. The method of claim 12, wherein said fluid medium is removed by evaporation.

14. The method of claim 12, wherein substantially all of said fluid medium is removed.

15. The method of claim 1, wherein said fluid medium comprises a liquid, gas, or super critical fluid.

16. The method of claim 1, wherein said contacting comprises flowing said dispersion into said hardenable resin material, said hardenable resin material residing within a container while sonicating.

17. The method of claim 2, further comprising contacting said fluid medium, dispersion, hardenable resin material, mixture, or any combination thereof, with a curing agent.

18. The method of claim 17, wherein said curing agent is activated by visible light, ultraviolet light, heat, radiation, or any combination thereof.

19. The method of claim 17, wherein said contacting with a curing agent occurs at least prior to said sonicating.

20. The method of claim 17, wherein said contacting with a curing agent occurs after sonicating has begun.

21. The method of claim 17, further comprising removing at least a portion of said fluid medium from said mixture while sonicating.

22. The method of claim 21, wherein substantially all of the fluid medium is removed.

23. The method of claim 22, wherein the fluid medium is removed by evaporation.

24. The method of claim 22, wherein said contacting with a curing agent occurs after substantially all of the fluid medium is removed.

25. The method of claim 2, wherein said curable resin comprises a thermally-curable or a radiation-curable resin.

26. The method of claim 25, wherein said thermally-curable resin comprises an epoxy resin, a polyester resin, an acrylic resin, a polyimide resin, or any combination thereof.

27. The method of claim 2, wherein said curable resin is at least partially uncured during contacting with said dispersion.

28. The method of claim 27, wherein said curable resin remains substantially uncured during contacting with said dispersion.

29. The method of claim 1, wherein said carbon nanotubes comprise SWNTs, LMNTs, MWNTs, or any combination thereof.

30. The method of claim 1, wherein said carbon nanotubes are unfunctionalized.

31. The method of claim 1, wherein said carbon nanotubes comprise greater than about 50 weight percent SWNTs.

32. The method of claim 1, wherein said carbon nanotubes comprise greater than about 95 weight percent SWNTs.

33. The method of claim 1, wherein said fluid medium comprises a solvent that is characterized as being miscible with said hardenable resin material.

34. The method of claim 1, wherein said fluid medium is capable of suspending individual carbon nanotubes.

35. The method of claim 1, wherein said fluid medium comprises dimethylformamide, toluene, tetrahydronaphthalene, decalin, dichlorobenzene, or any combination thereof.

36. The method of claim 1, wherein said dispersion is characterized as being homogeneous.

37. The method of claim 36, wherein the homogeneous dispersion comprises individual carbon nanotubes, aggregates of fewer than about 10 carbon nanotubes, or both.

38. The method of claim 36, wherein the homogeneous dispersion is substantially free of carbon nanotube agglomerates.

39. The method of claim 1, wherein said dispersion is characterized as having up to about 1.0 weight percent of carbon nanotubes, based on total weight of the dispersion.

40. The method of claim 39, wherein said dispersion is characterized as having at least about 0.0001 weight percent of carbon nanotubes, based on total weight of the dispersion.

41. The method of claim 40, wherein said dispersion is characterized as having from about 0.001 weight percent to about 0.1 weight percent of carbon nanotubes, based on total weight of the dispersion.

42. The method of claim 40, wherein said dispersion is characterized as having from about 0.003 weight percent to about 0.03 weight percent of carbon nanotubes, based on total weight of the dispersion.

43. A composition, comprising:
a matrix material; and
SWNTs having a weight fraction, relative to said matrix material, in the range of from about 0.0001 to less than 0.005, said composition having an electrical conductivity greater than about 10⁻⁹ S/cm.

44. The composition of claim 43, wherein said SWNTs have a weight fraction of at least about 0.0002.

45. The composition of claim 43, wherein said SWNTs have a weight fraction of at least about 0.0005.

46. The composition of claim 43, wherein said SWNTs have a weight fraction of at least about 0.001.

47. The composition of claim 43, wherein said SWNTs have a weight fraction of at least about 0.002.

48. The composition of claim 43, wherein said SWNTs comprise greater than about 50 percent by weight of single SWNTs.

49. The composition of claim 43, wherein said SWNTs are homogeneously dispersed in said composition.

50. The composition of claim 43, wherein said SWNTs are inhomogeneously dispersed in said composition.

51. The composition of claim 43, wherein said SWNTs are in the semi-dilute regime.

52. A composition, comprising:
a matrix material; and
non-functionalized SWNTs having a weight fraction, relative to said matrix material, in the range of from about 0.0001 to less than 0.0074, said composition having an electrical conductivity greater than about 10⁻⁹ S/cm.

53. A composition, comprising:
a crosslinked matrix material; and
SWNTs having a weight fraction, relative to said crosslinked matrix material, in the range of from about 0.0001 to less than 0.0074, said composition having an electrical conductivity greater than about 10⁻⁹ S/cm.

54. A composition, comprising:
a matrix material; and
SWNTs in the semi-dilute concentration regime, said composition having an electrical conductivity greater than about 10⁻⁹ S/cm.

55. A composition made according to the process of claim 1.

56. The composition of claim 54, wherein the matrix material is non-conductive.

57. The composition of claim 54, wherein the matrix material is semi-conductive.

58. The composition of claim 54, wherein the matrix material is conductive.

59. The composition of claim 54, wherein the concentration of SWNTs is above the percolation threshold.

60. An electrical component, comprising
a matrix material; and
SWNTs near the percolation threshold, said electrical component having an electrical conductivity greater than about 10⁻⁹ S/cm.

61. The electrical component of claim 60, wherein the electrical component comprises a fuse, a transistor, a resistor, a capacitor, a conductor, a thermistor, a sensor, a diode, or any combination thereof.

62. A method, comprising:
providing a composition comprising a matrix material and nanotubes near the percolation threshold; and
thermally controlling nanotube network formation within said matrix material.

63. The method of claim 62, wherein the concentration of nanotubes in the matrix material is within the semi-dilute regime.

64. The method of claim 62, wherein the concentration of nanotubes is above the percolation threshold below about 25° C.

65. The method of claim 62, wherein the concentration of nanotubes is above the percolation threshold below about 100° C.

66. The method of claim 62, wherein the concentration of nanotubes is above the percolation threshold below about 200° C.

67. The method of claim 62, wherein the concentration of nanotubes is above the percolation threshold below about 300° C.

68. The method of claim 62, wherein the concentration of nanotubes is below the percolation threshold above about 50° C.

69. The method of claim 62, wherein the concentration of nanotubes is below the percolation threshold above about 100° C.

70. The method of claim 62, wherein the concentration of nanotubes is below the percolation threshold above about 200° C.

71. The method of claim 62, wherein the concentration of nanotubes is below the percolation threshold above about 300° C.

72. The method of claim 62, wherein the nanotube network breaks upon heating and reforms upon cooling.

73. The method of claim 62, wherein the nanotubes comprise substantially single SWNTs.
